(19) United States
(12) Patent Application Publication
(10) Pub. No.: US 2015/0108110 A1
(43) Pub. Date: Apr. 23, 2015

(54) TEMPERATURE CONTROLLED HEATING UNIT

(71) Applicant: Carrier Commercial Refrigeration, Inc., Farmington, CT (US)

(72) Inventors: Otley Dwight Freymiller, Deerfield, WI (US); Jeffrey L. Sands, Freeport, IL (US); Ronald J. Glavan, Rockton, IL (US); Dennis J. Nelson, Rockford, IL (US)

(21) Appl. No.: 14/514,975

(22) Filed: Oct. 15, 2014

Related U.S. Application Data
(60) Provisional application No. 61/892,195, filed on Oct. 17, 2013.

(51) Int. Cl. A47J 37/06

(52) U.S. Cl. CPC A47J 37/0611
USPC 219/448.13

(57) ABSTRACT

A heating apparatus including a first heating plate configured to contact a first side of an object to heat the object and a second heating plate configured to contact a second side of the object opposite the first side to heat the object. The heating apparatus includes a controller configured to determine a temperature of the object based on sensor data received from a temperature sensor and to control a position of the first heating plate based on the determined temperature of the object.

### CROSS-REFERENCE TO RELATED APPLICATIONS

This application claims the benefit of U.S. provisional patent application Ser. No. 61/892,195, filed Oct. 17, 2013, the entire contents of which are incorporated herein by reference.

### BACKGROUND OF THE INVENTION

Embodiments of the invention relate to cooking apparatuses, and in particular to platens that are controlled by sensed temperatures.

Grills for cooking apply heat from a lower heating platen and from an upper heating platen to opposite sides of a food item to decrease cook times and to cook food evenly. However, differences types of foods or variations among a same type of food being cooked may result in some food items being fully cooked while other food items are not fully cooked, or even over-cooked. When food items being cooked include meat products, the food items must be cooked to a particular temperature for health reasons. Other food items may be cooked to different temperatures according to consumer preferences. In addition, in an environment in which a cooking device relies on an operator to control a position of the upper platen, food may be over-cooked if the operator is engaged in another task when the food reaches the fully-cooked temperature.

### BRIEF DESCRIPTION OF THE INVENTION

Embodiments of the present invention include a heating apparatus including a first heating plate configured to contact a first side of an object to heat the object and a second heating plate configured to contact a second side of the object opposite the first side to heat the object. The heating apparatus includes a controller configured to determine a temperature of the object based on sensor data received from a temperature sensor and to control a position of the first heating plate based on the determined temperature of the object.

Embodiments of the invention further include a method of controlling a cooking apparatus including determining a temperature of a food item between a first heating plate of the cooking apparatus and a second heating plate of the cooking apparatus and controlling a position of at least one of the first heating plate and the second heating plate based on the determined temperature by generating control signals to a motor that raises and lowers the first heating plate onto and away from the second heating plate.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a cooking apparatus according to one embodiment of the invention;

FIG. 2 illustrates a heat-flux detecting sensor according to an embodiment of the invention;

FIG. 3 is illustrates a contact temperature sensor according to an embodiment of the invention;

FIG. 4A illustrates a non-contact sensor according to an embodiment of the invention;

FIG. 4B illustrates a non-contact sensor according to another embodiment of the invention; and

FIG. 5 is a flow diagram of a method according to an embodiment of the invention.

### DETAILED DESCRIPTION OF THE INVENTION

Conventional grilling apparatuses heat food from above and below, but may heat food unevenly due to different types of foods or variations among a same type of food. Embodiments of the invention relate to controlling the position of heating plates of a grill based on a sensed or estimated temperature of the food being cooked.

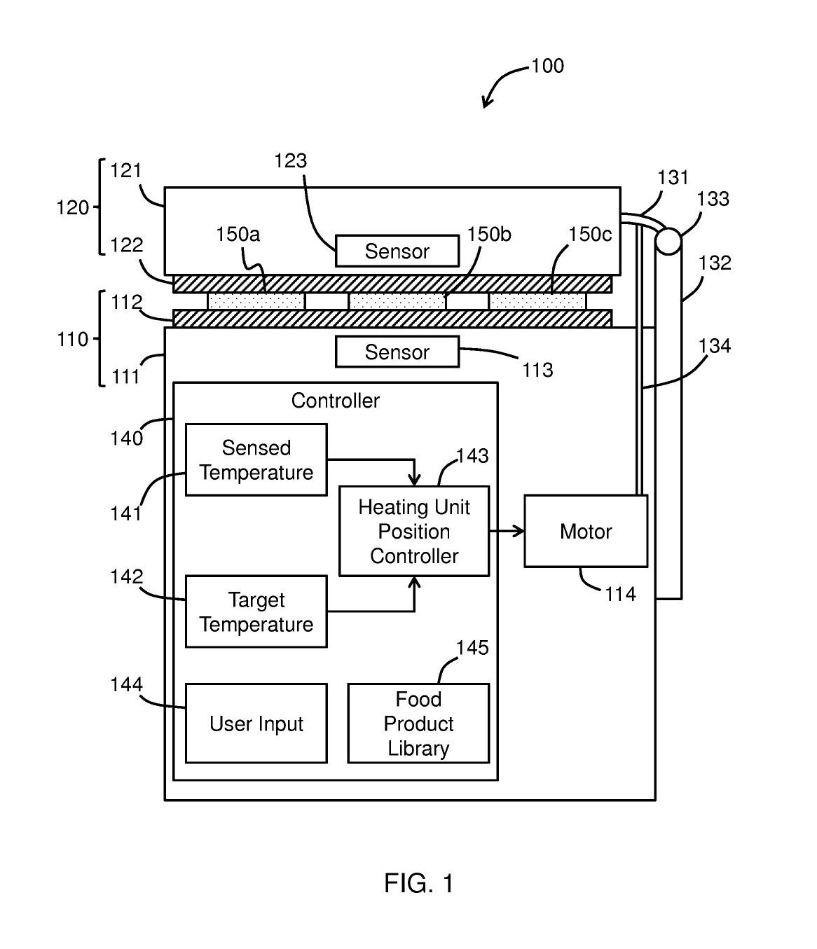

FIG. 1 is a diagram of a heating apparatus 100 according to an embodiment of the invention. In one embodiment, the heating apparatus 100 is a grilling apparatus for grilling food. The heating apparatus 100 includes a lower portion 110 including a base 111 that rests on the ground, floor or another surface. The lower portion also includes a heating plate 112, which may be referred to as a lower heating plate 112. The heating apparatus 100 also includes an upper portion 120 including a heating unit 121 that moves relative to the base 111. The heating unit 121 includes a heating plate 122.

The upper heating unit 121 and upper heating plate 122 are lifted relative to the lower portion 110 by a lifting mechanism, which may include a support arm 131 connected to the upper heating unit 121, a mounting structure 132, a hinge 133, and an actuator 134 that is driven by a motor 114 to raise and lower the upper heating unit 121 and upper heating plate 122. While FIG. 1 illustrates the mounting structure 132 mounted to the base 111, embodiments of the invention encompass the upper portion 110 being raised and lowered by any mechanism, including a ceiling-mounted mechanism, a wall-mounted mechanism, and a base 111 mounted mechanism. Embodiments of the invention encompass any lifting motion, including a linear lifting motion, a rotational lifting motion, or any combination of a linear and rotational lifting motion. Embodiments of the invention also encompass the lower heating plate 112 being lowered to separate from the upper portion 120 instead of, or in addition to, the upper heating unit 121 being lifted.

The heating apparatus 100 includes one or more sensors, including a sensor 123 located in the upper heating unit 121, and a sensor 113 located in the base 111. It is understood, however, that embodiments of the invention may include only one of the sensors 123 and 113, multiple sensors in the upper heating unit 121, multiple sensors in the base 111, one or more sensors on an outside surface of the upper heating unit 121, upper heating plate 122, base 111, or lower heating plate 112, one or more sensors between the upper heating unit 121 and the base 111, or sensors located at any other location capable of detecting a temperature of, or around, the food items 150a, 150b, and 150c.

The heating apparatus 100 also includes a controller 140 to control a cooking cycle, including a temperature of the upper and lower heating plates 122 and 112, and the raising and lowering of the upper portion 120. In embodiments of the invention, the controller 140 determines a temperature of the foot items 150a-150c, either by direct measurement or by an indirect measurement of a heat flux, and controls the cooking cycle based on the determined temperature of the food items.

The controller 140 receives as an input from the sensors 113 and 123 a sensed temperature 141 of the food items 150a-150c and compares the sensed temperature 141 to a target temperature 142. The target temperature 142 is a pre-set temperature at which the food items 150a-150c should be cooked. In one embodiment, the target temperature 142 is determined by a user input 144, such as a keypad or other input device that permits a user to provide temperature information. In another embodiment, the target temperature is retrieved from a food product library 145 stored in memory of the controller 140. In such an embodiment, the heating apparatus 100 may automatically sense a type of food being cooked, or a user may input a type of food being cooked via the user input 144, and the controller 140 may retrieve the correct cooking temperature from the food product library 145. In one embodiment, the food product library 145 includes multiple target temperatures for a food item, such as a first temperature corresponding to a “medium-rare” level of cooking meat, a second temperature corresponding to a “medium” level of cooking the meat, and a third temperature corresponding to a “well-done” level of cooking the meat. A user may select the type of food item and also the desired cooking level, and the controller 140 may retrieve the correct target temperature 142 information from the food product library 145 based on the user's input.

The heating unit position controller 143 determines whether the sensed temperature 141 meets or exceeds a predetermined target temperature 142 and controls the position of the upper portion 120 accordingly by controlling the motor 141 and actuator 134. For example, if the heating unit position controller 143 determines that the sensed temperature 141 has reached a fully-cooked target temperature 142, the heating unit position controller 143 controls the motor 114 to raise the upper portion 120 to remove the upper heating plate 122 off of the food items 150a-150c to end the cooking cycle. Accordingly, food may be cooked to a desired temperature without a user checking the temperature, and a gap between the upper and lower heating plates 122 and 122 need not be measured.

In addition to adjusting the position of the upper portion 120, the input power to the upper and lower heating plates 122 and 112 may also be adjusted based on the temperature of the product.

In embodiments of the invention, the controller 140 includes at least one processor and memory, as well as supporting logic and passive electrical components. The heating unit position controller 143 may include one or more comparators, and may include software executed by the processor of the controller 140.

In one embodiment, the sensors 113 and 123 detect a temperature of the food items 150a-150c directly, by contacting the food items 150a-150c or by directing a non-contact light or radio wave beam to the food items 150a-150c. In another embodiment, the sensors 113 and 123 measure the temperature of the food items 150a-150c indirectly, by measuring the heat flux or temperature change of one or both of the upper and lower heating plates 122 and 112, and estimating the temperature of the food items 150a-150c based on the heat flux or the temperature change of the heating plats 122 or 112.

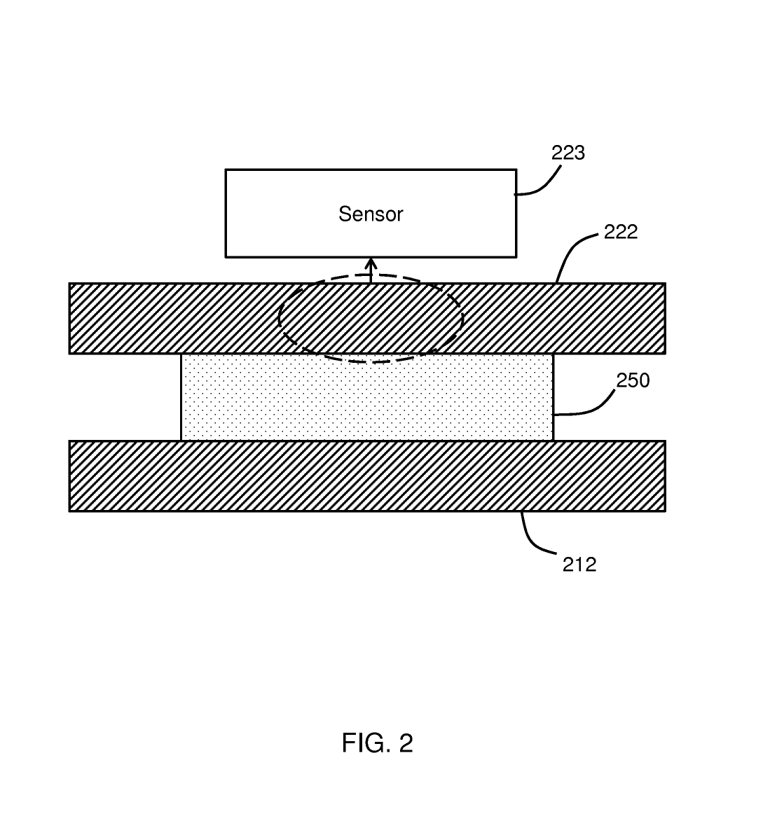

FIG. 2 illustrates an example of a sensor 223 that indirectly determines the temperature of a food item 250. The food item 250 is positioned between an upper heating plate 222 and a lower heating plate 212. The sensor 223 detects the temperature of the upper heating plate 222, represented by the dashed lines in FIG. 2. A controller, such as the controller 140 of FIG. 1, may analyze the temperature data over time to determine the rate of change of temperature of the upper heating plate 222, and to estimate the temperature of the food product 250 based on the rate of change For example, when the upper heating plate 222 initially contacts a cold food item 250, the rate of change of heat of the upper heating plate 222 will be greater than after the food item 250 has been cooked to a higher temperature. Accordingly, the controller may detect the decreased rate of change of temperature of the upper heating plate 222 and may estimate the temperature of the food item 250 based on the rate of change of the temperature. The controller may then control the upper heating plate 222 to be removed from the food item 250.

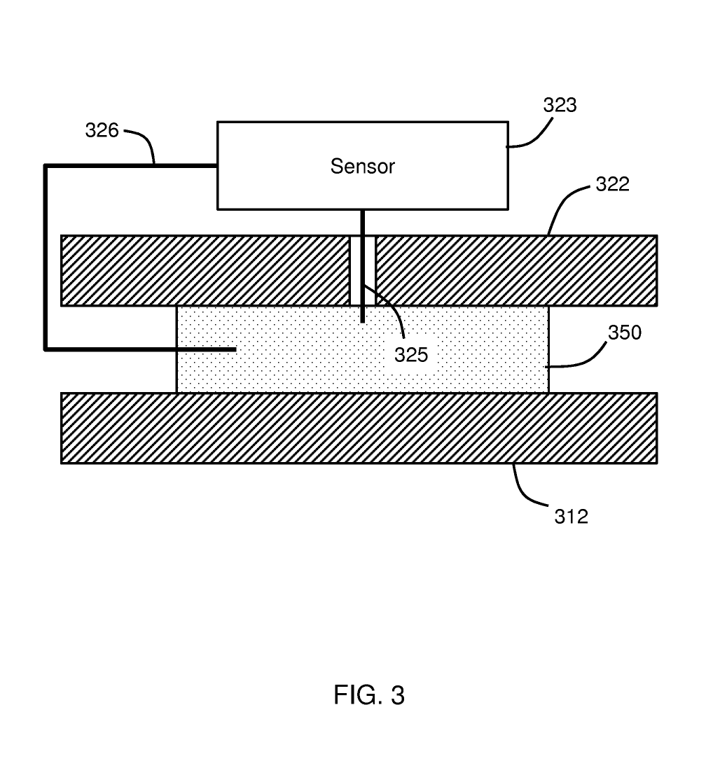

FIG. 3 illustrates an example of a sensor 323 that directly determines the temperature of a food item 350. The food item 350 is positioned between an upper heating plate 322 and a lower heating plate 312. The sensor 323 detects the temperature of the food item 350 via one or more probes 325 and 326. The probes 325 and 326 may be positioned to detect a temperature inside the food item 350 as illustrated in FIG. 3, or the probes 325 and 326 may contact only an outside surface of the food item 350.

FIG. 3 illustrates a first probe 325 that is inserted through an opening in the upper heating plate 322, and a second probe that is introduced to the food item 350 from a side of the food item 350, or from in between the upper and lower heating plates 322 and 312. Embodiments of the invention encompass introducing temperature sensing probes to a food item 350 from any direction. A controller, such as the controller 140 of FIG. 1, may analyze the temperature data and may then control the upper heating plate 322 to be removed from the food item 350 when the controller determines that the food item 350 is fully cooked.

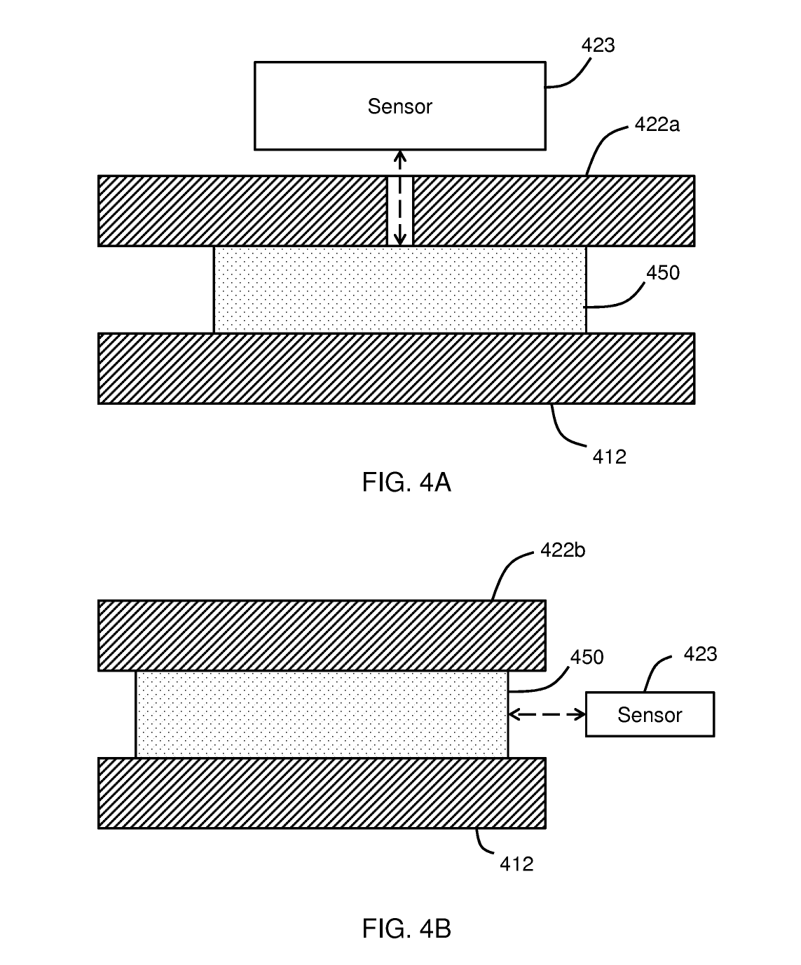

FIGS. 4A and 4B illustrate detecting the temperature of a food item 450 with non-contact temperature sensors 423. In FIG. 4A, the food item 450 is positioned between an upper heating plate 422a and a lower heating plate 412. A beam, represented by dashed arrows, is emitted from the sensor 423, transmitted through an opening in the upper heating plate 422a and reflected energy is detected by the sensor 423. In FIG. 4B, the food item 450 is positioned between an upper heating plate 422b and a lower heating plate 412. A beam, represented by dashed arrows, is emitted by the sensor 423 from a side of the food item 450 between the upper and lower heating plates 422 and 412, and reflected energy is detected by the sensor 423. Accordingly, the outer temperature of the food item 450 is detected, and the inside temperature may be estimated by a controller, such as the controller 140 of FIG. 1. The controller then controls the position of the upper heating plate 422a or 422b based on the detected temperature. For example, if the controller determines that the food item 450 is fully cooked, the controller lifts the upper heating plate 422a or 422b off of the food item 450.

In embodiments of the invention, the non-contact sensor 423 may emit any type of beam, including infrared (IR), any other radio frequency (RF) beam, any light beam, or any other type of beam that can be generated, reflected, and measured to determine a temperature of the food item 450.

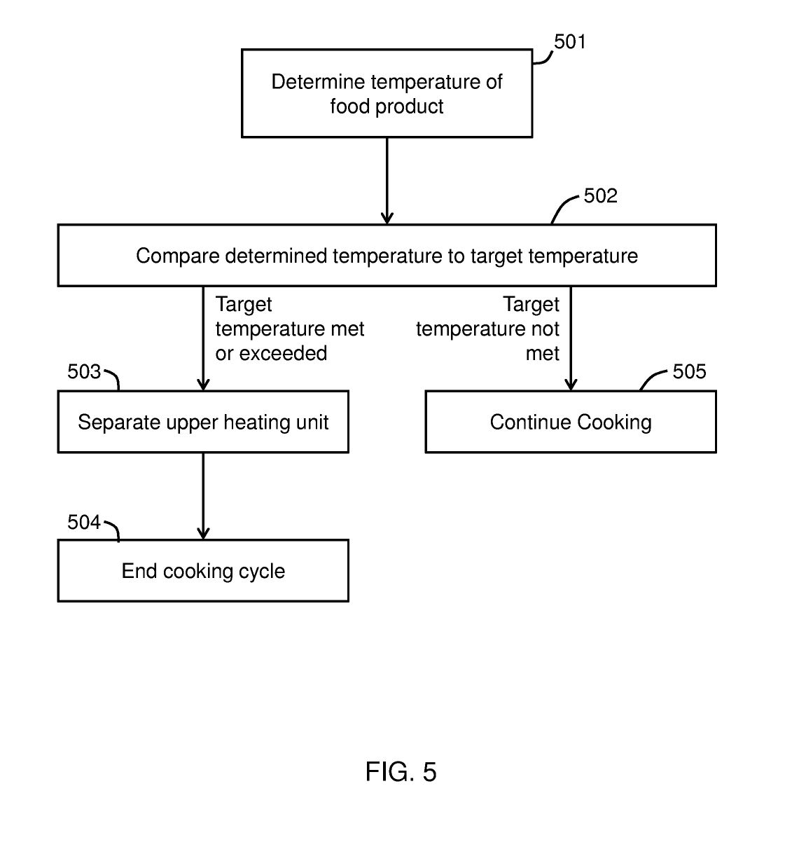

FIG. 5 is a flow diagram illustrating a method according to an embodiment of the invention. In block 501, a temperature of a food product is determined. The temperature may be determined by a contact temperature sensor that physically contacts a food item, by a non-contact food sensor that detects the food item temperature by detecting energy of a beam reflected off of the food item, or by detecting a temperature or heat flux of the heating plates that are heating the food item.

In block 502, the determined food temperature is compared with a target temperature. If the determined food temperature meets or exceeds the target temperature, then it is determined that the food item is cooked to a desired temperature, and a control circuit generates output signals to control a motor to separate an upper heating unit from the food item in block 503. The cooking cycle is then ended in block 504. For example, an upper heating plate and a lower heating plate may be turned off, may be turned down to a touch-safe temperature or another, low temperature. In addition, a notification may be generated, such as a sound or visual notification to notify an operator that the food is ready.

If it is determined in block 502 that the determined temperature does not meet or exceed the target temperature, then the cooking cycle continues in block 505. In some embodiments, if the determined temperature is outside a threshold range, a control circuit may generate control signals to the upper and lower heating plates to adjust a temperature of the upper and lower heating plates.

While embodiments have been described with respect to lifting an upper heating unit to separate the upper heating unit from a lower heating plate, embodiments of the invention encompass any manner of separating the upper heating plate from the lower heating plate, including lowering the lower heating plate while keeping the upper heating plate in the same position, and moving both of the upper and lower heating plates away from each other.

Embodiments of the invention relate to controlling a position of an upper heating unit in a two-sided cooking apparatus, having an upper heating plate and a lower heating plate. The cooking unit includes temperature sensors that detect a temperature of the heating plates or a food item. A controller determines the temperature of the food item and controls the position of the upper heating unit based on the determined temperature. If the temperature of the food item meets or exceeds a predetermined target temperature, the controller lifts the upper heating unit off of the food item and ends a cooking cycle.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A heating apparatus, comprising:
a first heating plate configured to contact a first side of an object to heat the object;
a second heating plate configured to contact a second side of the object opposite the first side to heat the object; and
a controller configured to determine a temperature of the object based on sensor data received from a temperature sensor and to control a position of the first heating plate based on the determined temperature of the object.

2. The heating apparatus of claim 1, wherein the controller is configured to separate the first heating plate from the object based on determining that the determined temperature of the object is equal to or greater than a target temperature.

3. The heating apparatus of claim 1, wherein the controller is configured to receive from a user input a desired state of the object, to automatically determine a target temperature associated with the desired state, and to separate the first heating plate from the object based on determining that the determined temperature is equal to or greater than the target temperature.

4. The heating apparatus of claim 1, wherein the controller is configured to detect a type of the object, to automatically determine a target temperature associated with the type of the object, and to separate the first heating plate from the object based on determining that the determined temperature is equal to or greater than the target temperature.

5. The heating apparatus of claim 1, further comprising:
a sensor including a probe to contact the object to detect a temperature of the object and to transmit the sensor data to the controller.

6. The heating apparatus of claim 1, further comprising:
a sensor configured to emit a beam at the object to detect a temperature of the object and to transmit the sensor data to the controller.

7. The heating apparatus of claim 1, further comprising:
a sensor configured to detect a temperature of one of the first heating plate and the second heating plate and to transmit the sensor data to the controller,
wherein the controller is configured to analyze the detected temperature over time to calculate a rate of change of the temperature of the first heating plate or the second heating plate, and to estimate the temperature of the object based on one of the calculated rate of change or an integral over time of the temperature of the first heating plate or the second heating plate.

8. The heating apparatus of claim 1, further comprising:
a sensor configured to detect a surface temperature of the object and to transmit the sensor data to the controller,
wherein the controller is configured to analyze the detected temperature over time to calculate a rate of change of the surface temperature, and to estimate an inside temperature of the object based on one of the calculated rate of change or an integral over time of the surface temperature of the object.

9. A method of controlling a cooking apparatus, comprising:
determining a temperature of a food item between a first heating plate of the cooking apparatus and a second heating plate of the cooking apparatus; and
controlling, by a controller, a position of at least one of the first heating plate and the second heating plate based on the determined temperature by generating control signals to a motor that separates the first heating plate from the second heating plate.

10. The method of claim 9, wherein the controller is configured to separate the first heating plate from the food item based on determining that the determined temperature of the food item is equal to or greater than a target temperature.

11. The method of claim 9, wherein the controller is configured to receive from a user input a desired state of the food item, to automatically determine a target temperature associated with the desired state, and to separate the first heating plate from the food item based on determining that the determined temperature is equal to or greater than the target temperature.

12. The method of claim 9, wherein the controller is configured to detect a type of the food item, to automatically determine a target temperature associated with the type of the food item, and to separate the first heating plate from the food item based on determining that the determined temperature is equal to or greater than the target temperature.

13. The method of claim 9, wherein determining the temperature of the food item includes physically contacting the food item with a temperature probe and transmitting resulting temperature data to the controller.

14. The method of claim 9, wherein determining the temperature of the food item includes directing a beam onto the food item, detecting reflected energy from the food item, and measuring a temperature of the food item based on the reflected energy.

15. The method of claim 9, wherein determining the temperature of the food item includes detecting a temperature of one of the first heating plate and the second heating plate, analyzing, by the controller, the detected temperature over time to calculate on of a rate of change or an integral of the temperature of the first heating plate or the second heating plate over time, and estimating the temperature of the food item based on the calculated rate of change or integral of the temperature of the first heating plate or the second heating plate.

16. The method of claim 9, wherein determining the temperature of the food item includes detecting a surface temperature of the food item, analyzing, by the controller, the detected surface temperature over time to calculate on of a rate of change or an integral of the surface temperature of over time, and estimating an internal temperature of the food item based on the calculated rate of change or integral of the surface temperature of the food item.
